(19) United States
(12) Patent Application Publication
(10) Pub. No.: US 2025/0125068 A1
(43) Pub. Date: Apr. 17, 2025

(54) MULTICORE CABLE

(71) Applicant: SUMITOMO ELECTRIC INDUSTRIES, LTD., Osaka (JP)

(72) Inventor: Takuya KINOSHITA, Tochigi (JP)

(21) Appl. No.: 18/785,624

(22) Filed: Jul. 26, 2024

(30) Foreign Application Priority Data
Oct. 17, 2023 (JP) 2023-179056

(51) Int. Cl. H01B 7/02; H01B 1/02; H01B 3/30; H01B 7/18

(52) U.S. Cl. CPC H01B 7/02; H01B 1/026; H01B 3/305; H01B 3/306; H01B 7/18

(57) ABSTRACT

A multicore cable includes a core formed by twisting a plurality of coated electric wires; and an outer sheath disposed outside the core. A thickness of the outer sheath is 0.03 mm or less. Each of the plurality of coated electric wires includes a conductor and an insulator covering the conductor. A thickness of the insulator is 5 μm or less. The insulator contains one or more selected from polyimide and polyamide-imide as a resin material.

### CROSS-REFERENCE TO RELATED APPLICATIONS

This patent application is based on and claims priority to Japanese Patent Application No. 2023-179056 filed on Oct. 17, 2023, the entire contents of which are incorporated herein by reference.

### TECHNICAL FIELD

The present disclosure relates to a multicore cable.

### BACKGROUND

Japanese Laid-open Patent Application Publication No. 2019-046647 discloses a multicore cable including a cable core formed by twisting multiple electric wires, a hold wrap tape wound around the cable core, a shield member provided on an outer periphery of the hold wrap tape, and a jacket covering an outer side of the shield member.

### SUMMARY

A multicore cable of the present disclosure includes a core formed by twisting a plurality of coated electric wires; and an outer sheath disposed outside the core. A thickness of the outer sheath is 0.03 mm or less. Each of the plurality of coated electric wires includes a conductor and an insulator covering the conductor. A thickness of the insulator is 5 μm or less. The insulator contains one or more selected from polyimide and polyamide-imide as a resin material.

### BRIEF DESCRIPTION OF THE DRAWINGS

FIG. 1 is a cross-sectional view of a multicore cable according to one embodiment of the present disclosure in a plane perpendicular to a longitudinal direction thereof;

FIG. 2 is a cross-sectional view of a multicore cable according to one embodiment of the present disclosure in a plane perpendicular to a longitudinal direction thereof; and

FIG. 3 is a cross-sectional view of a coated electric wire included in the multicore cable according to one embodiment of the present disclosure in a plane perpendicular to a longitudinal direction thereof.

### DETAILED DESCRIPTION

### Problems to be Solved by the Invention

A multicore cable in which multiple electric wires and the like are assembled and integrated is used in various applications.

In recent years, for the purpose of examination, medical treatment, and the like, a device and a tube provided with a multicore cable is inserted into a living body. In order to reduce a load on the living body, it is required to reduce the outer diameter of a multicore cable used for the living body.

However, when the coating thickness of a coated electric wire included in a multicore cable is reduced in order to reduce the outer diameter of the multicore cable, the coating of the coated electric wire included in the multicore cable is melted by heat when an outer sheath of the multicore cable is molded, and the coated electric wires may be welded to each other.

### Effects of the Invention

According to the present disclosure, a multicore cable is provided, in which the outer diameter is reduced and the welding of the coated electric wires included therein is suppressed.

Embodiments will be described below.

### Description of Embodiments of the Present Disclosure

First, the embodiments of the present disclosure will be listed and described. In the following description, the same or corresponding elements are denoted by the same reference symbols, and the same description thereof will not be repeated.

(1) A multicore cable according to one aspect of the present disclosure includes a core formed by twisting a plurality of coated electric wires; and an outer sheath disposed outside the core. A thickness of the outer sheath is 0.03 mm or less. Each of the plurality of coated electric wires includes a conductor and an insulator covering the conductor. A thickness of the insulator is 5 μm or less. The insulator contains one or more selected from polyimide and polyamide-imide as a resin material.

By setting the thickness of the outer sheath to 0.03 mm or less, the outer diameter of the multicore cable can also be reduced.

The insulator contains one or more selected from polyimide and polyamide-imide as a resin material, and thus the melting point of the insulator can be increased, and the insulator can be prevented from being melted by heat when the outer sheath is molded. Therefore, the coated electric wires included in the multicore cable according to one aspect of the present disclosure can be prevented from being welded to each other.

By setting the thickness of the insulator to 5 μm or less, the outer diameter of the coated electric wire can be reduced, and the outer diameter of the multicore cable including the coated electric wire can also be reduced.

(2) In (1), an outer diameter of the conductor may be 0.032 mm or less.

By setting the outer diameter of the conductor to 0.032 mm or less, the outer diameter of the multicore cable can be particularly reduced.

(3) In (1) or (2), the conductor may include a central portion containing iron and an outer peripheral portion containing copper and disposed outside the central portion.

The conductor includes the central portion containing iron, and thus the strength of the conductor is increased, the outer diameter of the conductor is reduced, and breaking can be suppressed even when the multicore cable is repeatedly bent.

Additionally, the conductor includes the outer peripheral portion containing copper, and thus the electrical characteristic of the conductor can be improved.

(4) In any one of (1) to (3), a metal shield layer may be provided between the core and the outer sheath.

The metal shield layer can suppress noise from being added to a signal propagating through the coated electric wire. Additionally, the metal shield layer can suppress the influence of noise on external devices.

### Details of Embodiments of the Present Disclosure

A specific example of a multicore cable according to one embodiment of the present disclosure (hereinafter referred to as “the present embodiment”) will be described below with reference to the drawings. The present invention is not limited to these examples, but is defined by the scope of the claims, and is intended to include all modifications within the meaning and scope equivalent to the scope of the claims.

In the present specification, the description may be provided by adding “first”, “second”, “third”, and the like to the names of members, such as a first coated electric wire, a second coated electric wire, and a third coated electric wire. “first”, “second”, “third”, and the like are merely described to identify each member and prevent confusion in the description, and do not indicate an arrangement, a priority order, and the like. Therefore, when there is no particular fear of confusion or when the description is collectively provided, the term “coated electric wire” can be used.

### Multicore Cable

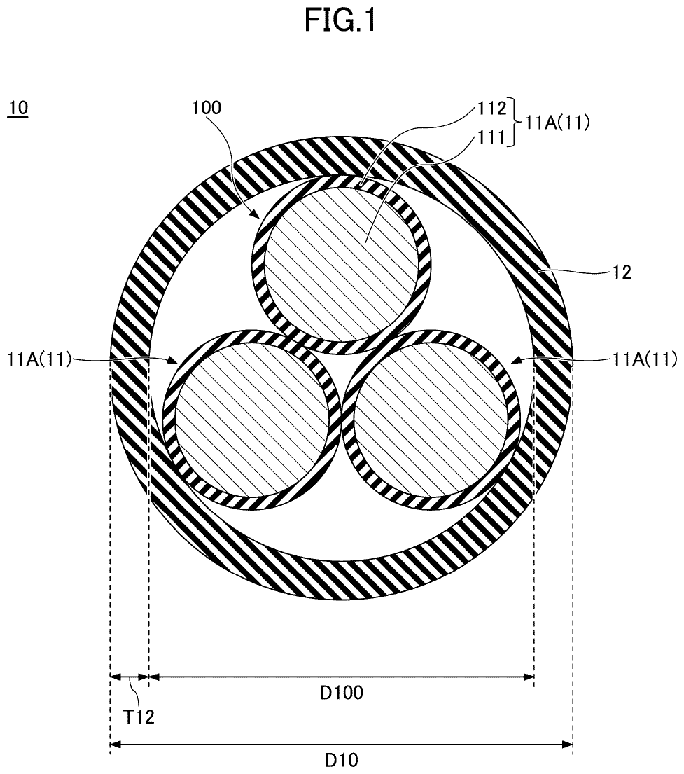

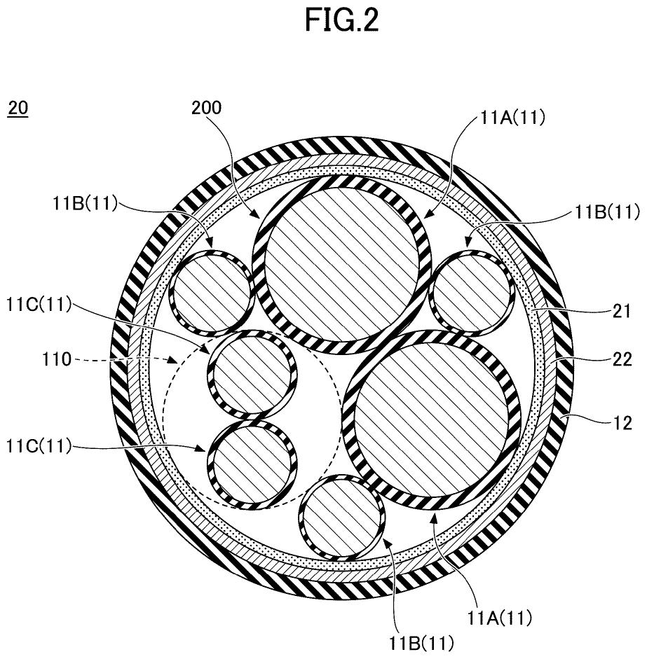

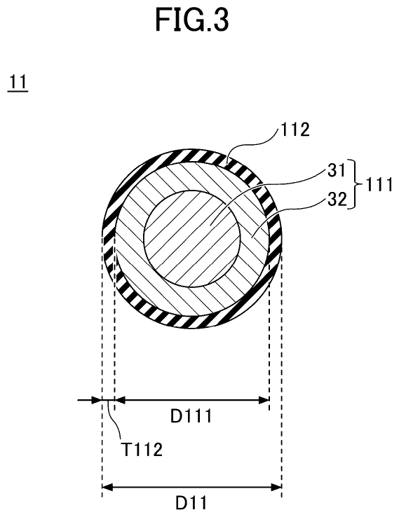

FIG. 1 illustrates a configuration example of a multicore cable 10 of the present embodiment in a cross section perpendicular to a longitudinal direction thereof. FIG. 2 illustrates another configuration example of a multicore cable 20 of the present embodiment in a cross section perpendicular to a longitudinal direction thereof. FIG. 3 illustrates a configuration example of a coated electric wire 11 in a cross section perpendicular to a longitudinal direction thereof.

FIG. 2 corresponds to a modified example of the multicore cable of the present embodiment. Thus, the description will be provided mainly with reference to FIG. 1 and FIG. 3, and the description will be provided with reference to FIG. 2 as necessary.

As illustrated in FIG. 1, the multicore cable 10 of the present embodiment includes a core 100 in which multiple coated electric wires 11 are twisted together, and an outer sheath 12 disposed outside the core 100.

Each member included in the multicore cable of the present embodiment will be described.

### (1) Core

### (1-1) Configuration of Coated Electric Wire Included in Core

The configuration of the coated electric wire 11 included in the core 100 is not particularly limited.

For example, as illustrated in FIG. 1, the core 100 may have a configuration in which multiple first coated electric wires 11A having the same outer diameter and the same material are twisted together.

Additionally, as in the multicore cable 20 illustrated in FIG. 2, a core 200 may have a configuration in which multiple coated electric wires, such as a first coated electric wire 11A, a second coated electric wire 11B, and a third coated electric wire 11C, having different configurations such as outer diameters are twisted together. As in the third coated electric wire 11C in the core 200 illustrated in FIG. 2, two coated electric wires may be twisted to form a twisted-pair electric wire 110, and then twisted with other coated electric wires 11 to form the core 200.

The configurations of the core and the coated electric wires included in the multicore cable of the present embodiment are not limited to the forms of FIG. 1 and FIG. 2. The core of the multicore cable of the present embodiment can be configured such that any number of coated electric wires selected according to the application are combined and twisted.

The core 100 may be formed by twisting multiple coated electric wires 11 all together. That is, the core 100 may be arranged such that the coated electric wires 11 form multiple layers from the center of the core 100, and the coated electric wires 11 may be twisted all together at the same twist pitch instead of being twisted in each layer. By twisting the multiple coated electric wires 11 all together, the coated electric wires 11 included in the multicore cable 10 become less likely to be broken even when the multicore cable 10 is repeatedly bent.

### (1-2) Coated Electric Wire

As illustrated in FIG. 1 and FIG. 3, the coated electric wire 11 includes a conductor 111 and an insulator 112 covering the conductor 111. (Conductor)

The outer diameter D111 (see FIG. 3) of the conductor 111 can be selected according to the application and is not particularly limited. However, from the viewpoint of particularly reducing the outer diameter D10 of the multicore cable 10, the outer diameter D111 of the conductor 111 may be reduced.

Therefore, for example, the outer diameter D111 of the conductor 111 can be set to 0.060 mm or less. By setting the outer diameter D111 of the conductor 111 to 0.060 mm or less, the outer diameter D10 of the multicore cable 10 can also be reduced.

The outer diameter D111 of the conductor 111 may be 0.032 mm or less. By setting the outer diameter D111 of the conductor 111 to 0.032 mm or less, the outer diameter D10 of the multicore cable 10 can be particularly reduced.

The lower limit of the outer diameter D111 of the conductor 111 is not particularly limited, but may be, for example, 0.02 mm or greater. That is, the outer diameter D111 of the conductor 111 may be, for example, 0.02 mm or greater and 0.060 mm or less, or may be 0.02 mm or greater and 0.032 mm or less.

The outer diameter D111 of the conductor 111 can be obtained by measuring two diameters orthogonal to each other in a cross section perpendicular to the longitudinal direction of the coated electric wire 11 and averaging the measured diameters. The outer diameter D11 of the coated electric wire 11, the outer diameter D10 of the multicore cable 10, and the outer diameter D100 of the core 100 can be measured and calculated in the same manner except that the object to be evaluated is changed to the coated electric wire 11, the multicore cable 10, and the core 100.

When the coated electric wires 11 including the conductors 111 having different sizes are included as in the multicore cable 20 illustrated in FIG. 2, for example, the conductors 111 of at least some of the coated electric wires 11 may be configured to have the outer diameters D111 satisfying the above range. The outer diameters D111 of the conductors 111 of all the coated electric wires 11 may satisfy the above range.

The conductor 111 may include a single conductor wire or multiple conductor wires. When the conductor includes multiple conductor wires, the multiple conductor wires may be twisted together. That is, when the conductor includes multiple conductor wires, the conductor may be a stranded wire of the multiple conductor wires.

The material of the conductor 111 is not particularly limited, and for example, a copper alloy or copper can be used. As copper, for example, annealed copper can be used. The conductor 111 may be plated with tin or silver. A silver-copper alloy may also be used in terms of electrical conductivity and tensile strength.

In the coated electric wire 11 included in the multicore cable 10 of the present embodiment, the outer diameter D111 of the conductor 111 can also be reduced. However, if the outer diameter D111 of the conductor 111 is reduced, the conductor 111 is likely to be broken when the multicore cable 10 is repeatedly bent.

Thus, as illustrated in FIG. 3, when a strength exceeding that of the copper alloy wire is required, the conductor 111 of the coated electric wire 11 may also include a central portion 31 containing iron and an outer peripheral portion 32 containing copper arranged outside the central portion 31.

The conductor 111 includes the central portion 31 containing iron, and thus the strength of the conductor 111 is increased, the outer diameter D111 of the conductor 111 is reduced, and breaking can be suppressed even when the multicore cable 10 is repeatedly bent.

Additionally, the conductor 111 includes the outer peripheral portion 32 containing copper, and thus the electrical characteristic of the conductor 111 can be maintained satisfactorily.

Examples of the material containing iron used for the central portion 31 include stainless steel such as SUS316L.

Examples of the material containing copper used for the outer peripheral portion 32 include annealed copper, copper alloy, and the like.

The conductor 111 including the central portion 31 and the outer peripheral portion 32 can be manufactured by, for example, drawing a base material obtained by plating a surface of stainless steel with copper. Although FIG. 3 schematically illustrates the conductor 111 and indicates an example in which the central portion 31 and the outer peripheral portion 32 are arranged concentrically, the present invention is not limited to such a form.

### (Insulator)

The insulator 112 may contain one or more selected from polyimide and polyamide-imide as a resin material.

The insulator 112 contains one or more selected from polyimide and polyamide-imide as a resin material, and thus the melting point of the insulator 112 can be increased, and the insulator 112 can be prevented from being melted by heat when the outer sheath 12 is molded. Therefore, the coated electric wires 11 of the multicore cable 10 of the present embodiment can be prevented from being welded to each other.

The insulator 112 can be manufactured by, for example, coating the surface of the conductor 111 with the resin by heating. Therefore, the insulator 112 may be formed of only the resin.

The thicknesses T112 of the insulator 112 is not particularly limited, and may be, for example, 5 μm or less. By setting the thicknesses T112 of the insulator 112 to 5 μm or less, the outer diameter D11 of the coated electric wire 11 can be reduced, and the outer diameter D10 of the multicore cable 10 including the coated electric wire 11 can also be reduced.

The lower limit of the thickness T112 of the insulator 112 is not particularly limited, and may be, for example, 2 μm or greater. That is, the thickness T112 of the insulator 112 may be, for example, 2 μm or greater and 5 μm or less.

The thicknesses T112 of the insulator 112 can be a value obtained by subtracting the outer diameter D111 of the conductor 111 from the outer diameter D11 of the coated electric wire 11 and dividing the result by 2.

### (2) Outer Sheath

The outer sheath 12 can be disposed outside the core 100.

The multicore cable 10 includes the outer sheath 12, and thus the coated electric wire 11 and the like disposed inside can be protected.

The outer sheath 12 may contain fluororesin as a resin material.

The outer sheath 12 contains fluororesin as a resin material, and thus sufficient strength can be obtained even when the thicknesses T12 of the outer sheath 12 is reduced.

As the fluororesin, for example, one or more selected from polytetrafluoroethylene (PTFE), tetrafluoroethylene-perfluoroalkyl vinyl ether copolymer (PFA), tetrafluoroethylene-hexafluoropropylene copolymer (FEP), ethylene-tetrafluoroethylene copolymer (ETFE), and the like can be used.

The resin material contained in the outer sheath 12 may be crosslinked or may not be crosslinked.

The outer sheath 12 may be formed only of the resin material described above, but the outer sheath 12 may contain one or more additives selected from a flame retardant, a flame retardant aid, an antioxidant, a lubricant, a coloring agent, a reflection-imparting agent, a masking agent, a processing stabilizer, a plasticizer, and the like, in addition to the resin material.

The thickness T12 of the outer sheath 12 can be 0.03 mm or less. By setting the thickness T12 of the outer sheath 12 to 0.03 mm or less, the outer diameter D10 of the multicore cable 10 can also be reduced.

The lower limit of the thickness T12 of the outer sheath 12 is not particularly limited, but may be, for example, 0.01 mm or greater. That is, the thickness T12 of the outer sheath 12 may be, for example, 0.01 mm or greater and 0.03 mm or less.

The thickness T12 of the outer sheath 12 can be a value obtained by subtracting the outer diameter D100 of the core 100 from the outer diameter D10 of the multicore cable 10 and dividing the result by 2.

### (3) Other Members

The multicore cable of the present embodiment may include any suitable member in addition to the core 100 and the outer sheath 12.

For example, as illustrated in FIG. 2, the multicore cable 20 may include a metal shield layer 22 between the core 200 and the outer sheath 12.

### (3-1) Metal Shield Layer

The metal shield layer 22 can suppress noise from being added to a signal propagated through the coated electric wire 11. Additionally, the metal shield layer 22 can also suppress the influence of noise on external devices.

The metal shield layer 22 may contain a conductive material.

For example, the metal shield layer 22 can be formed by spirally winding a conductive tape including a conductive layer along the longitudinal direction of the core 200.

In this case, the conductive tape may be formed of only the conductive layer, or may be formed by disposing the conductive layer on one or more surfaces selected from among the upper surface and the lower surface of the base material.

The material of the conductive layer is not particularly limited, but may include, for example, a metal, and may be, for example, a metal foil. When the conductive layer contains a metal, the material of the metal is not particularly limited, and for example, copper, a copper alloy, aluminum, an aluminum alloy, or the like can be used.

The material of the base material is not particularly limited, and the base material may be formed of, for example, an insulating material such as an organic polymer material or a nonwoven fabric. Examples of the organic polymer material include a polyester resin such as polyethylene terephthalate (PET), a polyolefin resin such as polypropylene, a vinyl resin such as polyvinyl chloride, and the like. The base material may be a base material containing an insulating material, or may be a base material formed of only an insulating material.

When the metal shield layer 22 is formed by winding the conductive tape, the winding direction of the conductive tape can be suitably selected, and may be the same as or different from the twisting direction of the core 200, for example.

The metal shield layer 22 may be formed of a metal wire. In this case, the metal shield layer 22 can be formed by arranging the metal wire so as to have any structure selected from a braided structure and a spiral structure.

As the material of the metal wire, copper, aluminum, a copper alloy, or the like can be used. The metal wire may be plated with silver or tin on the surface thereof. Therefore, for example, a silver-plated copper alloy, a tin-plated copper alloy, or the like can be used as the metal wire.

### (3-2) Hold Wrap

As illustrated in FIG. 2, the multicore cable 20 may have a hold wrap 21 covering the outer surface of the core 200.

The hold wrap 21 can stabilize the arrangement of the coated electric wires 11 included in the multicore cable 20 and can bundle the coated electric wires 11.

As the hold wrap 21, for example, a resin tape can be used.

The resin used for the resin tape may be one or more selected from fluororesin such as a polytetrafluoroethylene (PTFE) resin, a polyester resin such as a polyethylene terephthalate (PET) resin, polyethylene (PE), and the like, which are excellent in heat resistance, abrasion resistance, and the like.

The resin tape used as the hold wrap 21 may contain a conductive material such as carbon in order to have conductivity. The conductive substance may be added to the resin forming the resin tape so as to be dispersed therein. Alternatively, a metal tape in which a copper foil or an aluminum foil is disposed on the surface of the resin tape may be used.

The winding direction of the hold wrap 21 may be the same as or different from the twisting direction of the coated electric wires 11 included in the core 200. Here, as the hold wrap 21, a metal tape formed of copper foil, aluminum foil, or the like may be used instead of the resin tape.

When the hold wrap 21 and the metal shield layer 22 are included as in the multicore cable 20 illustrated in FIG. 2, the hold wrap 21 and the metal shield layer 22 may be arranged in this order from a position close to the core 200.

What is claimed is:

1. A multicore cable comprising:
a core formed by twisting a plurality of coated electric wires; and
an outer sheath disposed outside the core,
wherein a thickness of the outer sheath is 0.03 mm or less,
wherein each of the plurality of coated electric wires includes a conductor and an insulator covering the conductor,
wherein a thickness of the insulator is 5 μm or less, and
wherein the insulator contains one or more selected from polyimide and polyamide-imide as a resin material.

2. The multicore cable as claimed in claim 1, wherein an outer diameter of the conductor is 0.032 mm or less.

3. The multicore cable as claimed in claim 1, wherein the conductor includes a central portion containing iron and an outer peripheral portion containing copper, the outer peripheral portion being disposed outside the central portion.

4. The multicore cable as claimed in claim 1, further comprising a metal shield layer between the core and the outer sheath.
